(19) United States
(12) Patent Application Publication
(10) Pub. No.: US 2019/0237968 A1
(43) Pub. Date: Aug. 1, 2019

(54) ENERGY STORAGE ENHANCED GENERATOR BLOCK LOADING

(71) Applicant: S&C Electric Company, Chicago, IL (US)

(72) Inventors: Michael James Higginson, Mount Prospect, IL (US); Paul Michael Pabst, Glen Ellyn, IL (US); Jie Tang, Evanston, IL (US); Ernst Camm, The Villages, FL (US)

(73) Assignee: S&C Electric Company, Chicago, IL (US)

(21) Appl. No.: 16/217,077

(22) Filed: Dec. 12, 2018

Related U.S. Application Data
(60) Provisional application No. 62/622,983, filed on Jan. 29, 2018.

(51) Int. Cl. H02J 3/14; H02K 7/18; H02P 9/04; H02J 3/32

(52) U.S. Cl. CPC H02J 3/14; H02J 3/32; H02P 9/04; H02K 7/18

(57) ABSTRACT

A method for providing power to loads in a micro-grid during a block load event, where the micro-grid includes a rotating generator and a fast-responding energy storage system. The method determines that the micro-grid has been disconnected from the utility grid and then starts the generator to provide electrical power to the loads. The method causes the generator to electrically charge the energy storage system, and electrically couples the loads to the generator while the storage system is being charged. The energy storage system detects that the frequency of the generator is falling as a result of being electrically coupled to the loads, and starts discharging in response to the falling frequency to provide power to the loads to reduce the amount of power that is needed to be supplied to the loads by the generator.

### CROSS-REFERENCE TO RELATED APPLICATION

This application claims the benefit of priority from the U.S. Provisional Application No. 62/622,983, filed on Jan. 29, 2018, the disclosure of which is hereby expressly incorporated herein by reference for all purposes.

### BACKGROUND

### Field

This invention relates generally to a method for reducing significant frequency changes of a power system in response to a block load being coupled to the power system and, more particularly, to a method for reducing significant frequency changes of a low-inertia power system provided within a micro-grid in response to a block load being coupled to the power system that includes switching a fast-responding energy storage system from a charging mode to a discharging mode when the load is coupled to the power system.

### Discussion

An electrical power distribution utility, referred to herein as a utility grid, provides three-phase electrical power on a power distribution network to deliver power at the proper voltage magnitude and frequency for a number of loads, such as homes, businesses, manufacturing facilities, etc. The utility grid includes various power sources, substations, switching devices, feeder lines, lateral lines, circuit breakers, transformers, current and voltage measurement devices, etc. that operate to deliver the three-phase power to the loads in a controlled and stable manner.

Some utility grids may include one or more micro-grids, where each micro-grid includes electrical loads and one or more power sources, such as photovoltaic cells, generators, battery energy storage systems, wind farms, etc., and where the power sources may be distributed throughout the micro-grid. A micro-grid is connected to the utility grid by a suitable disconnect switch so that the micro-grid can be disconnected from the utility grid in the event of unavailability of the utility source (e.g. because of a fault occurring in the utility grid), where the various power sources in the micro-grid then support the loads in the micro-grid. Further, the power sources in the micro-grid may be generating power during normal operation when the micro-grid is connected to the utility grid, where the micro-grid power sources may be reducing the amount of power that the loads in the micro-grid are drawing from the utility grid, or may be placing power onto the utility grid. Typically, when the micro-grid is disconnected from the utility grid after an outage, breakers in the micro-grid are also opened prior to the micro-grid power sources being switched on to allow the power sources to start. Once the power sources are providing electrical energy, then the breakers are closed in a certain sequence to add load to the sources. This operation typically occurs very quickly where significant load is coupled to the power sources in a relatively short amount of time, which is referred to herein as a block load event.

The power sources in a micro-grid are often low-inertia power sources, such as combustion based rotating generators, that only generate a small amount of power relative to the power provided by the utility grid. The low inertia is a consequence of a relatively small rotating mass in the generator where coupling or decoupling of loads to the micro-grid have an effect on the frequency of the generator. Thus, when the block load event occurs, the rotating speed of the generator usually significantly decreases. In other words, when the kinetic energy of the rotating mass in the generator is converted to electrical energy to meet the power demand, the rotating mass slows down causing the reduction in frequency. Thus, the mechanical rotation of the generator needs time to ramp up in speed and power output to meet the increased electrical demand. More specifically, the frequency supplied by a rotating generator varies based on the generator inertia and the size of the load being applied, where the rate of change of the frequency is proportional to the difference in mechanical power P_{mechanical}, i.e., generator output, and electrical power P_{electrical}, i.e., electrical load on the generator, divided by the inertia constant of the generator as shown by equation (1) below.

$$\frac{d w}{d t} ∝ \frac{{P}_{mechanical} - {P}_{electrical}}{Inertia} \qquad ( 1 )$$

Thus it can be seen that during a block load event, the frequency will decrease as the generator increases its active power output to match the load, and recover when the generator output exceeds the load. The same phenomenon occurs when load is removed from the generator in that the reduced conversion of mechanical energy to electrical energy causes the rotating generator to speed up and increase the frequency. These types of frequency deviations can limit the generator's ability to accept or reject loads, and cause power quality issues at the loads that are undesirable.

### SUMMARY

The present disclosure describes a method for providing power to the loads in a micro-grid during a block load event when the micro-grid is electrically disconnected from a utility grid, where the micro-grid includes one or more rotating generators and a fast-responding energy storage system such as a battery energy storage system. The method determines that the micro-grid has been disconnected from the utility grid and starts the rotating generators to provide electrical power to the loads. The method then causes the generators to electrically charge the energy storage system, and electrically couples the loads to the generators while the energy storage system is being charged. The energy storage system detects that the frequency of the generators is falling as a result of being electrically coupled to the loads, where the energy storage system then starts discharging to provide power to the loads, which reduces the amount of power that is needed to be supplied to the loads from the generators so as to reduce the generator frequency reduction.

Additional features of the present disclosure will become apparent from the following description and appended claims, taken in conjunction with the accompanying drawings.

### BRIEF DESCRIPTION OF THE DRAWINGS

FIG. 1 is a simplified schematic block diagram of an electrical power distribution network including a micro-grid; and

FIG. 2 is a flow chart diagram showing a process for coupling loads to a generator in the micro-grid during a block load event.

### DETAILED DESCRIPTION OF THE EMBODIMENTS

The following discussion of the embodiments of the disclosure directed to a method for limiting significant frequency changes of a low-inertia power system in a micro-grid in response to a bulk load being coupled to the power system is merely exemplary in nature, and is in no way intended to limit the disclosure or its applications or uses.

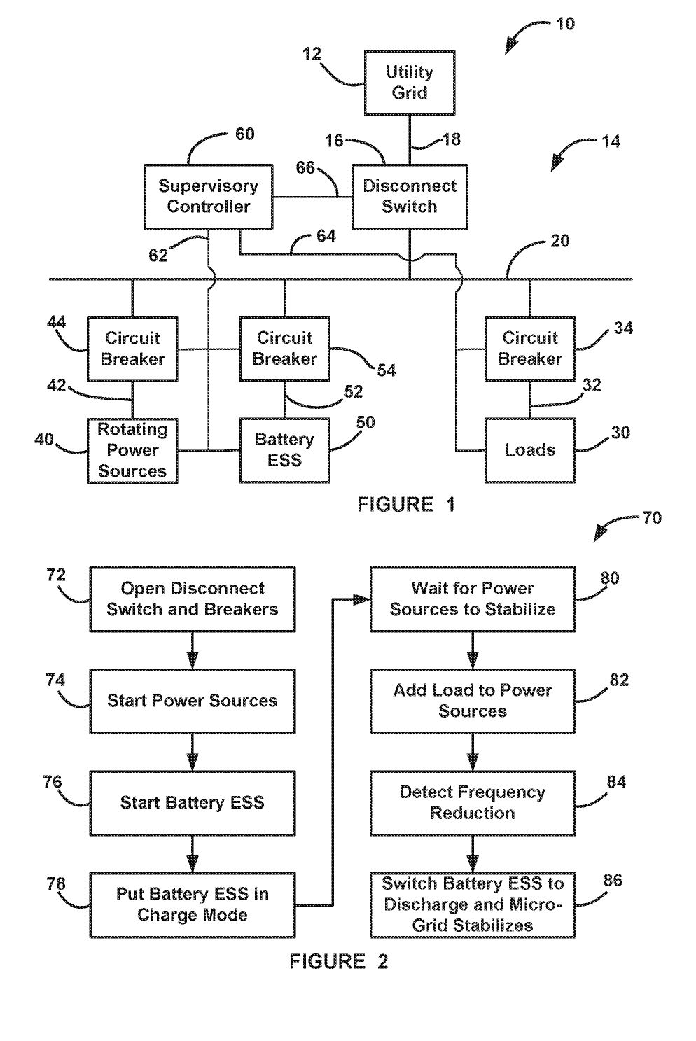

FIG. 1 is a block diagram of an electrical power distribution network 10 including a utility grid 12 and a micro-grid 14 electrically coupled together by an electrical line 18, where a micro-grid disconnect switch 16 operates as a point of common coupling (PCC) between the utility grid 12 and the micro-grid 14. The network 10 is intended to represent any electrical power distribution system or network of any size and configuration that provides electrical power from any number or type of power plants (not shown) over any suitable distance on any type of transmission line (not shown) to electrical substations (not shown) to be distributed on feeder lines (not shown) to any suitable load.

A feeder bus 20 is connected to the electrical line 18 on the micro-grid side of the switch 16 in the micro-grid 14. The feeder bus 20 provides

power to a number of loads 30 in the micro-grid 14 on an electrical line 32, where the loads 30 are intended to generally represent all of the loads that draw power in the micro-grid 14. A circuit breaker 34 is provided in the line 32 that is able to connect or disconnect the loads 30 from the bus 20 during various power control schemes, for example, the power scheme discussed herein, where the circuit breaker 34 is intended to represent all of the circuit breakers that may be coupled to the various loads 30 in the micro-grid 14.

The micro-grid 14 includes a number of rotating power sources 40 electrically coupled to the bus 20 by electrical line 42, where the rotating power sources 40 are intended to represent any number of power sources distributed within the micro-grid 14, and which may be low-inertia combustion based rotating generators of the type discussed above. A circuit breaker 44 is provided in the line 42 and is able to connect and disconnect the power sources 40 from the bus 20 also based on the various power schemes and control of the micro-grid 14, where the circuit breaker 44 is intended to represent all of the circuit breakers that may be provided in the micro-grid 14 for the number and location of the power sources 40 therein.

The micro-grid 14 also includes a battery energy storage system 50 electrically coupled to the feeder bus 20 by electrical line 52 through a circuit breaker 54, where the battery energy storage system 50 is intended to represent any suitable fast-responding energy storage system (ESS) that is able to be charged and discharged through a suitable electrical control scheme, and is operable to instantaneously provide electrical power to the micro-grid 14 to power to the loads 30 at least for a short period of time when desired. As will be appreciated by those skilled in the art, the battery energy storage system 50 will include an inverter (not shown) that converts DC power from batteries within the battery energy storage system 50 to AC power to supply the loads 30 when the battery energy storage system 50 is in a discharge mode and converts AC power to DC power when the battery energy storage system 50 is receiving power from the bus 20 in a charge mode. The battery energy storage system 50 can employ any suitable electrical configuration of battery cells of any suitable battery chemistry.

The micro-grid 14 also includes a supervisory controller 60 that may be a number of controllers distributed throughout the micro-grid 14 that control the position of the circuit breakers 34, 44 and 54, starting and stopping of the rotating power sources 40, discharging and charging of the battery energy storage system 50, etc., where the controller 60 provides various commands and receives various data on control lines 62, 64 and 66 consistent with any suitable micro-grid control scheme.

As discussed above, the power sources 40 may be of the type that provide electrical power through rotation of a mechanical mass whose frequency is affected as the number of loads are connected and disconnected therefrom, where a bulk load event when the disconnect switch 16 is first opened may have a significant frequency reduction effect on the power sources 40. Further, voltage magnitude deviations of the rotating power sources 40 will also occur during a block load event as a result of the impact on reactive power, but is not as significant to micro-grid stability as the frequency deviations. It is noted that in a typical operation, the rotating power sources 40 are not operating when the disconnect switch 16 is closed and the loads 30 are obtaining electrical power from the utility grid 12. However, there may be times when the power sources 40 are providing electrical power even though the micro-grid 14 is connected to the utility grid 12. It is further noted that although the discussion herein is concerned with frequency changes of the rotating power sources 40, those frequency changes are a result of the impact of active power changes in the micro-grid 14.

As will be discussed in detail below, the present disclosure proposes a method for supplying power to the loads 30 during a block load event when the disconnect switch 16 is opened to disconnect the micro-grid 14 from the utility grid 12 that includes starting and ramping up the rotating power sources 40 to meet the electrical demands of the loads 30 and using battery power from the battery energy storage system 50 during the generator ramp up to reduce the effect that the loads 30 have on the frequency of the power sources 40. Although the main thrust of the invention is to compensate for frequency reduction during a block load event, as will be appreciated by those skilled in the art, the power control scheme discussed herein will also have application for load shedding event, where the frequency of the rotating power sources 40 increases as a result of loss of load, which also could have an effect on power stability in the micro-grid 14.

FIG. 2 is a flow chart diagram 70 depicting one embodiment for providing power to the loads 30 in the micro-grid 14 when the micro-grid 14 is disconnected from the utility grid 12 in the manner referred to above. At box 72, a disturbance in the utility grid 12 or a manual island initiation causes the disconnect switch 16 to open and disconnect the micro-grid 14 from the utility grid 12. When the micro-grid 14 is disconnected from the utility grid 12, some or all of the circuit breakers 34, 44 and 54 may also be opened in the micro-grid 14. For example, the circuit breaker 34 is opened to disconnect the loads 30 from the feeder bus 20, and the circuit breakers 44 and 54 may be opened to disconnect the rotating power sources 40 and the battery energy storage system 50 from the feeder bus 20, although that may not be necessary. At box 74, the rotating power sources 40 are started, and if the circuit breaker 44 had previously been opened, it is closed at that time. At box 76, the controller 60 starts the battery energy storage system 50 by sending a control signal to the inverter that causes the battery energy storage system 50 to operate as a voltage source, where it outputs the power that is needed to maintain the voltage of the micro-grid 14 at a certain voltage level.

At box 78, the controller 60 causes the battery energy storage system 50 to go into a charge mode by adjusting certain voltage and frequency biases in the inverter, where the battery energy storage system 50 charges and acts as a load on the power sources 40. The charge mode command can be initiated with a controlled ramp to allow the power sources 40 to ramp up the mechanical power output. At box 80, the controller 60 waits for the power sources 40 to stabilize in frequency in response to the load provided by the battery energy storage system 50. Once the power sources 40 stabilize, the circuit breaker 34 is closed at box 82 to couple the loads 30 to the power sources 40. When this occurs, the frequency of the power sources 40 decreases, which is detected by the inverter in the battery energy storage system 50 at box 84. Any suitable control mechanism can be employed to detect the frequency of the power signal on the line 52 for this purpose, for example, a droop control method discussed below. As is known by those skilled in the art, when the micro-grid 14 is operating at higher frequencies, the battery energy storage system 50 is charging and when the micro-grid 14 is operating at lower frequencies, the battery energy storage system 50 is discharging, where the rate of charging and discharging is proportional to the change in the frequency. The detection of the frequency reduction by the battery energy storage system 50 causes the battery energy storage system 50 to discharge at box 86 using the droop control method. and the micro-grid 14 stabilizes. Because the battery energy storage system 50 is discharging, the power output of the power sources 40 is reduced, where the block load seen by the power sources 40 is reduced by, for example, up to two times or more of the battery energy storage system rating. As the frequency of the micro-grid stabilizes, the battery energy storage system 50 continues to discharge until some point further in time where the battery energy storage system 50 is not needed for frequency and voltage stability.

As mentioned, in one embodiment the power sources 40 and the battery energy storage system 50 are controlled by a droop control method, where the frequency and voltage magnitude of the power sources 40 vary by equations (2) and (3) below, where f_{operating} is the operating frequency of the power sources 40, f_{no-load} is the frequency of the power sources 40 with no load, kₚ is the active power droop slope, Pₒᵤₜₚᵤₜ is the active power output of the power sources 40, V_{operating} is the operating voltage magnitude of the power sources 40 with a load attached thereto, V_{no-load} is the voltage magnitude of the power sources 40 with no load attached thereto, k_{q} is the reactive power droop slope, and Qₒᵤₜₚᵤₜ is the reactive power output of the power sources 40.

f_{operating}=f_{no-load}−kₚ·Pₒᵤₜₚᵤₜ (2)

V_{operating}=V_{no-load}−k_{q}·Qₒᵤₜₚᵤₜ (3)

Similar results may be achieved with other control methods than the droop method, or with less drastic swings in real power output from the battery energy storage system 50 if the energy storage system 50 is of an adequate size.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for providing electric power to loads in an electrical system, the electrical system including a rotating generator and a fast-responding energy storage system, the method comprising:
determining that the rotating generator needs to provide power for the loads;
starting the rotating generator;
causing the rotating generator to electrically charge the energy storage system;
electrically coupling the loads to the rotating generator while the energy storage system is being charged;
detecting that the frequency of the rotating generator is falling as a result of being electrically coupled to the loads; and
causing the energy storage system to discharge in response to the falling frequency to provide power to the loads from the energy storage system and to reduce the amount of power that is needed to be supplied to the loads by the rotating generator.

2. The method according to claim 1 wherein determining that the rotating generator needs to provide power to the loads includes determining that a utility grid has stopped providing power to the loads, where the rotating generator is a back-up power system.

3. The method according to claim 2 wherein the rotating generator, the energy storage system and the loads are part of a micro-grid coupled to the utility grid, wherein determining that the rotating generator needs to provide power to the loads includes opening a disconnect switch to disconnect the micro-grid from the utility grid.

4. The method according to claim 1 wherein detecting that the frequency of the rotating generator is falling includes detecting that the frequency is falling by the energy storage system.

5. The method according to claim 4 wherein causing the energy storage system to charge and discharge includes using a droop control method.

6. The method according to claim 1 wherein the energy storage system is a battery energy storage system including an inverter and batteries.

7. The method according to claim 1 wherein the rotating generator is a low-inertia generator.

8. A method for providing power to loads in a micro-grid during a block load event when the micro-grid is disconnected from a utility grid, the micro-grid including one or more low-inertia combustion based rotating generators and a battery energy storage system including an inverter and batteries, the method comprising:
determining that the micro-grid has been disconnected from the utility grid;
starting the one or more rotating generators;
electrically coupling the battery energy storage system to the one or more generators so that the battery energy storage system is electrically charged by the generators;
electrically coupling the loads to the one or more generators while the battery energy storage system is being charged;
detecting that the frequency of the one or more generators is falling by the battery energy storage system as a result of being electrically coupled to the loads; and
discharging the battery energy storage system in response to the falling frequency to provide power to the loads from the battery energy storage system and reduce the amount of power that is needed to be supplied to the loads from the one or more generators.

9. The method according to claim 8 wherein causing the energy storage system to charge and discharge includes using a droop control method.

10. A control system for providing power to loads in an electrical system, the electrical system including a rotating generator and a fast-responding energy storage system, the control system comprising:
a controller operably coupled to the electrical system, the rotating generator and the fast-responding energy storage system, the controller being configured in accordance with a set of non-transitory instructions stored within a memory thereof to:
determine that the rotating generator needs to provide power for the loads;
provide a start signal to the rotating generator, the rotating generator being responsive to the start signal to provide electric power;
couple the electric power from the rotating generator to charge the energy storage system;
electrically couple the loads to receive the electric power from the rotating generator while the energy storage system is being charged;
detect that a frequency of the electric power provided by the rotating generator is falling as a result of being electrically coupled to the loads; and
cause the energy storage system to discharge in response to the falling frequency to provide electric power to the loads from the energy storage system and reduce the amount of electric power that is needed to be supplied to the loads by the rotating generator.

11. The control system according to claim 10 wherein the controller is further configured to determine that a utility grid has stopped providing power to the loads and to determine that the rotating generator needs to provide electric power to the loads, where the rotating generator is a back-up power system.

12. The control system according to claim 11 wherein the rotating generator, the energy storage system and the loads are part of a micro-grid coupled to the utility grid, and wherein the controller is further configured to determine that the at least one rotating generator needs to provide power to the loads and to provide an open signal to a disconnect switch to disconnect the micro-grid from the utility grid.

13. The control system according to claim 10 wherein the controller is further configured to detect via the energy storage system that the frequency of the electric power provided by the rotating generator is falling.

14. The control system according to claim 13 wherein the non-transitory instructions comprise a droop control method.

15. The control system according to claim 10 wherein the energy storage system is a battery energy storage system including an inverter and batteries.

16. The control system according to claim 10 wherein the rotating generator is a low-inertia combustion based generator.
